(19) United States
(12) Patent Application Publication
(10) Pub. No.: US 2026/0349933 A1
(43) Pub. Date: Nov. 5, 2026

(54) REGION IDENTIFIER BASED ON INSTRUCTION FETCH ADDRESS

(71) Applicant: Arm Limited, Cambridge (GB)

(72) Inventor: Alexander Donald Charles Chadwick, Cambridge (GB)

(73) Assignee: Arm Limited, Cambridge (GB)

(21) Appl. No.: 19/124,685

(22) PCT Filed: Sep. 27, 2023
(86) PCT No.: PCT/GB2023/052503

§ 371 Date: Apr. 25, 2025

(30) Foreign Application Priority Data
Nov. 2, 2022 (GB) 2216292.9

(51) Int. Cl. G06F 12/14

(52) U.S. Cl. CPC G06F 12/145; G06F 12/1483; G06F 2212/1052

(57) ABSTRACT

An apparatus (100) comprising instruction fetch circuitry (105) responsive to an instruction fetch address to fetch an instruction associated with the instruction fetch address, processing circuitry (125) responsive to the instruction to perform, when the instruction comprises a request specifying a target memory address and the request specifying the target memory address is permitted, an operation dependent on the target memory address, and memory security circuitry (135) to, when the instruction comprises the request specifying the target memory address: determine, based on a predetermined slice of the instruction fetch address, a current region identifier; identify, based on the current region identifier, permissions information for requests issued in response to instructions associated with the current region identifier; determine, based on the permissions information, whether the request is prohibited; and issue, in response to determining that the request is prohibited, a response to the processing circuitry indicating that the request is prohibited.

The present technique relates to the field of data processing.

In a data processing system, instructions may be executed which involve accessing data or instructions in memory. For example, some instructions may comprise requests to read or write to locations in memory, while other instructions may comprise requests to execute instructions stored at locations in memory. It can be useful to be able to define permissions for these accesses.

Viewed from a first example of the present technique, there is provided an apparatus comprising:
instruction fetch circuitry responsive to an instruction fetch address to fetch an instruction associated with the instruction fetch address;
processing circuitry responsive to the instruction to perform, when the instruction comprises a request specifying a target memory address and the request specifying the target memory address is permitted, an operation dependent on the target memory address; and memory security circuitry to, when the instruction comprises the request specifying the target memory address:
   determine, based on a predetermined slice of the instruction fetch address, a current region identifier;
   identify, based on the current region identifier, permissions information for requests issued in response to instructions associated with the current region identifier;
   determine, based on the permissions information, whether the request is prohibited; and
   issue, in response to determining that the request is prohibited, a response to the processing circuitry indicating that the request is prohibited.

Viewed from another example, there is provided a method comprising:
fetching, in response to an instruction fetch address, an instruction associated with the instruction fetch address; and
when the instruction comprises a request specifying a target memory address:
   performing, in response to the instruction, when the request specifying the target memory address is permitted, an operation dependent on the target memory address; and
   determining, based on a predetermined slice of the instruction fetch address, a current region identifier;
   identifying, based on the current region identifier, permissions information for requests issued in response to instructions associated with the current region identifier;
   determining, based on the permissions information, whether the request is prohibited; and
   issuing, in response to determining that the request is prohibited, a response indicating that the request is prohibited.

Viewed from another example, there is provided a computer program which, when executed on a computer, causes the computer to provide:
instruction fetch program logic responsive to an instruction fetch address to fetch an instruction associated with the instruction fetch address;
processing program logic responsive to the instruction to perform, when the instruction comprises a request specifying a target memory address and the request specifying the target memory address is permitted, a request indicating the target memory location; and
memory security program logic to, when the instruction comprises the request specifying the target memory address:
   determine, based on a predetermined slice of the instruction fetch address, a current region identifier;
   identify, based on the current region identifier, permissions information for requests issued in response to instructions associated with the current region identifier;
   determine, based on the permissions information, whether the request is prohibited; and
   issue, in response to determining that the request is prohibited, a response to the processing program logic indicating that the request is prohibited.

Viewed from another example, there is provided a computer-readable storage medium to store the computer program described above. The computer-readable storage medium could be a transitory storage medium or a non-transitory storage medium.

Further aspects, features and advantages of the present technique will be apparent from the following description of examples, which is to be read in conjunction with the accompanying drawings, in which:

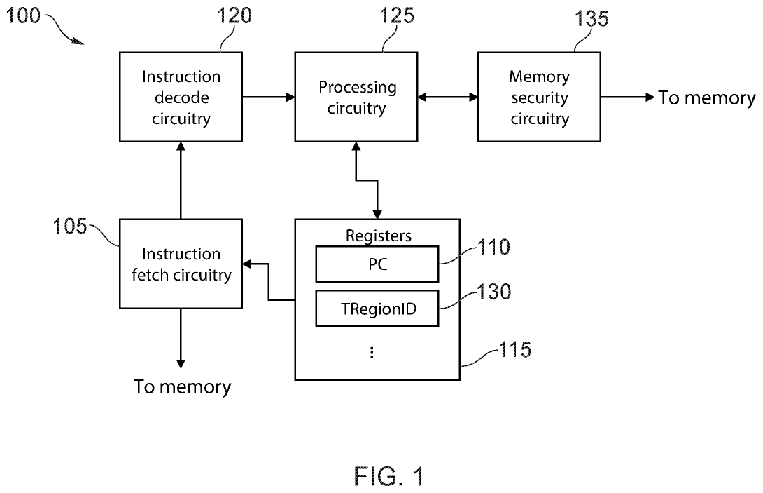

FIG. 1 schematically illustrates a data processing apparatus;

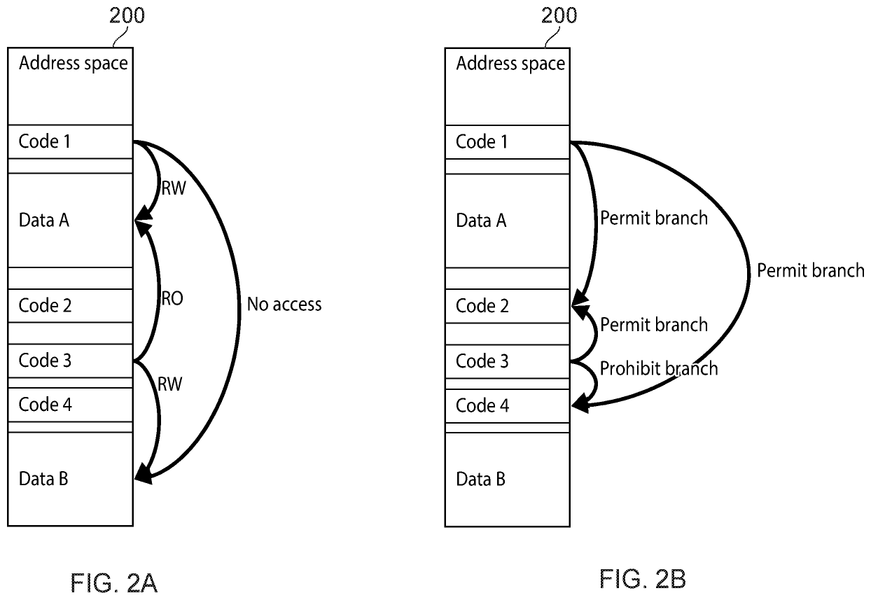

FIGS. 2A and 2B illustrate examples of permissions defined for a particular address space;

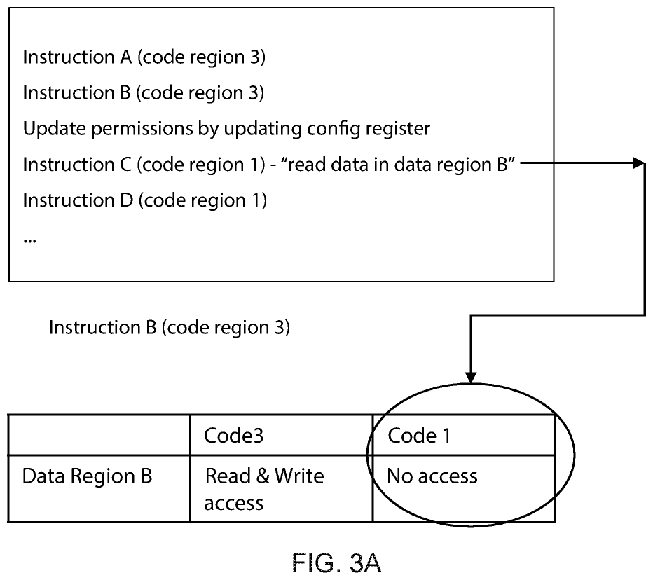

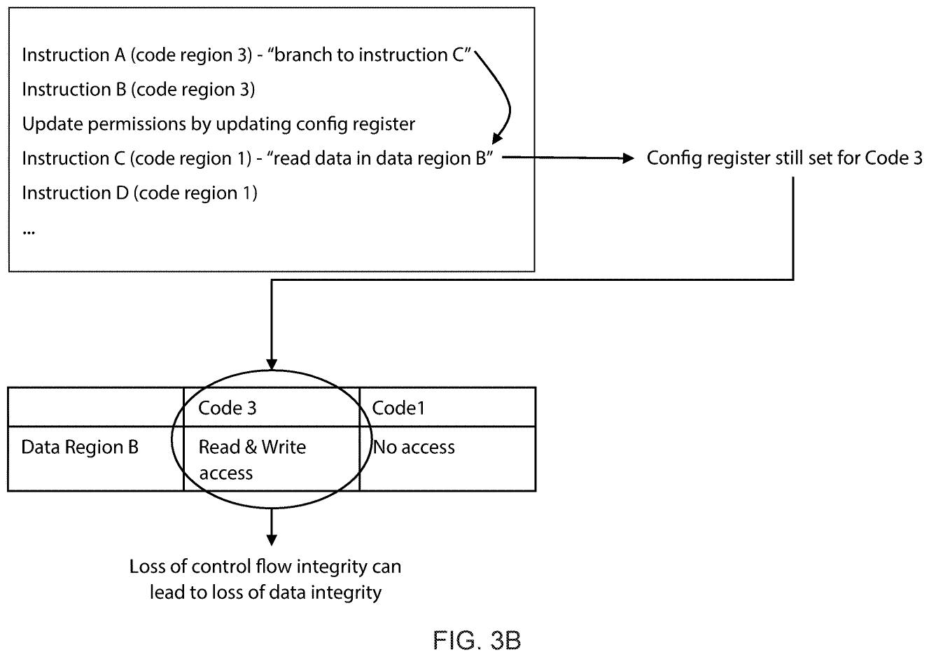

FIGS. 3A and 3B show examples of how instructions in different code regions may be executed;

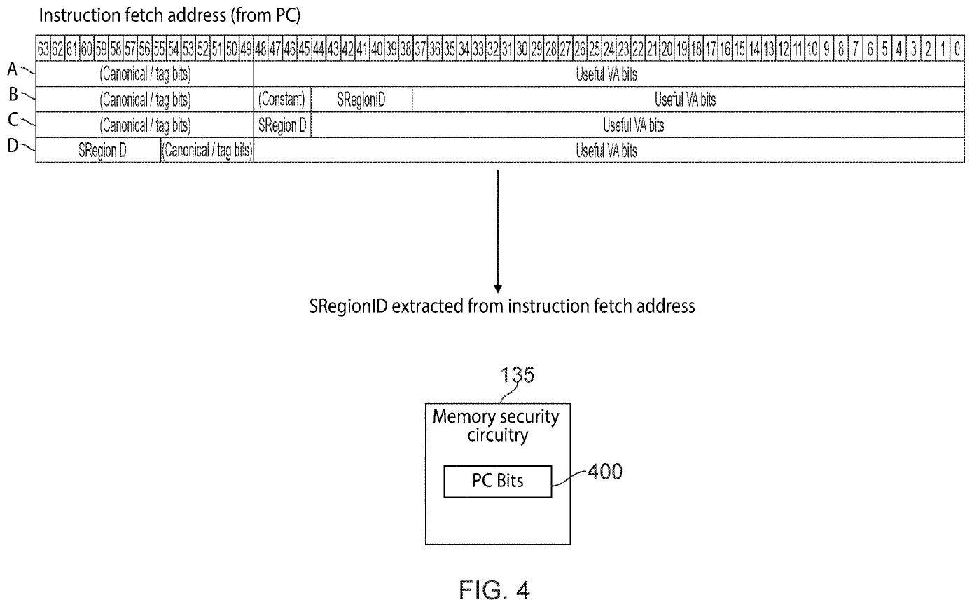

FIGS. 4 to 6 show various examples of determining a spatial region identifier (SRegionID) based on an instruction fetch address;

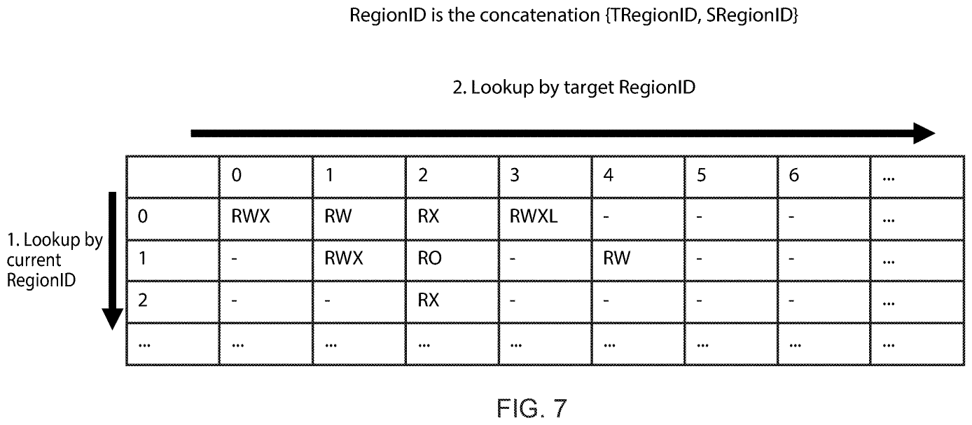

FIG. 7 shows an example of how read, write and execute permissions may be defined in a permissions table;

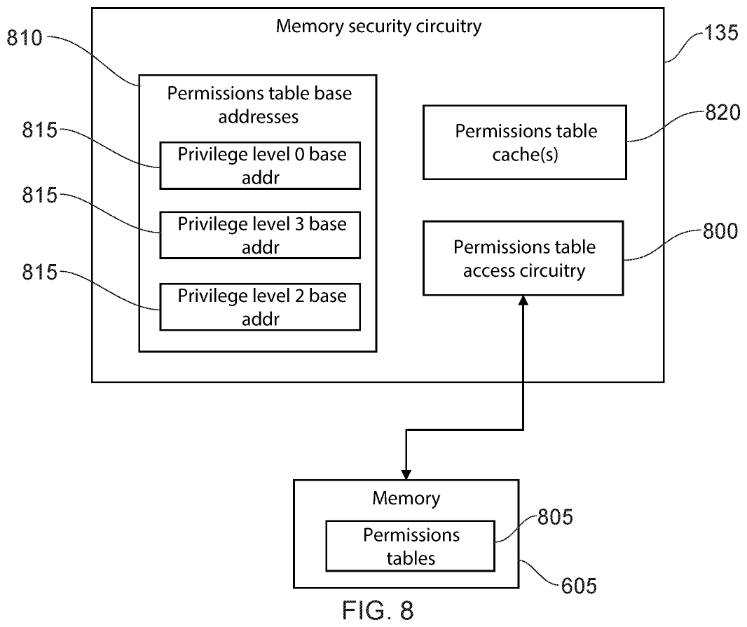

FIG. 8 shows an example of the circuitry which may be used to identify and access one or more permissions tables;

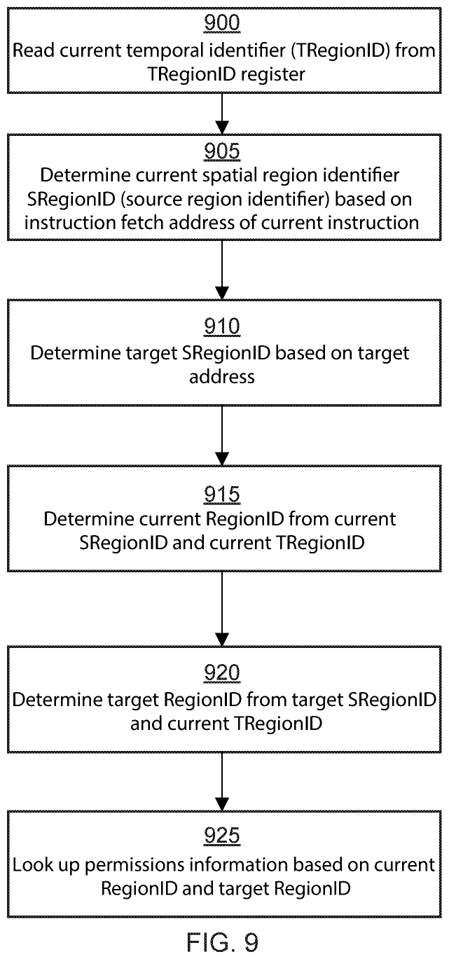

FIG. 9 is a flow diagram illustrating an example of a method which may be performed in response to a memory access request being issued;

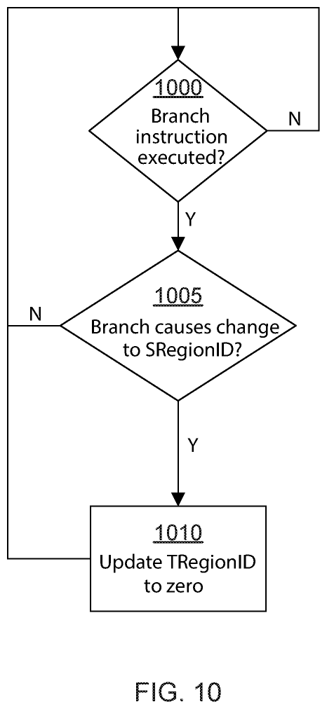

FIG. 10 is a flow diagram illustrating an example of how a data processing apparatus may react to the execution of some branch instructions; and

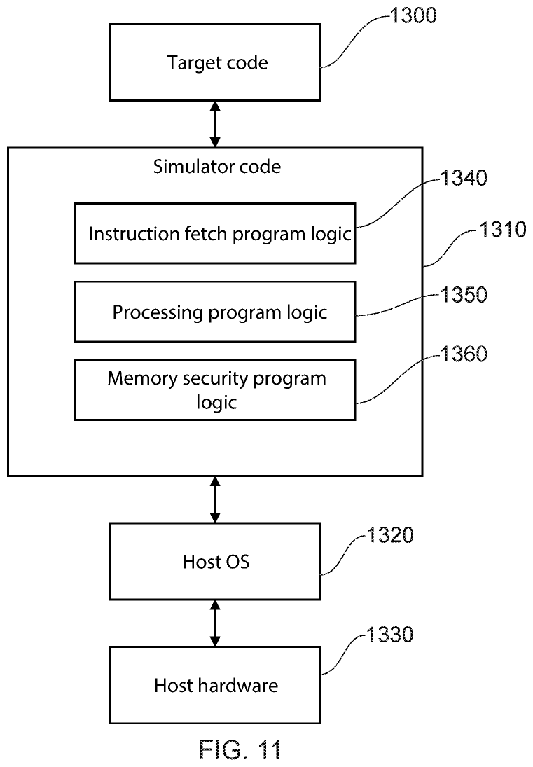

FIG. 11 illustrates a simulator implementation that may be used.

Before discussing example implementations with reference to the accompanying figures, the following description of example implementations and associated advantages is provided.

In accordance with one example configuration there is provided an apparatus comprising instruction fetch circuitry responsive to an instruction fetch address to fetch an instruction associated with the instruction fetch address. For example, the instruction fetch circuitry may fetch the instruction from a memory location indicated by the instruction fetch address (which could be a virtual address or a physical address, for example). In particular examples, the instruction fetch address may be a program counter (PC) address associated with the instruction.

The apparatus also comprises processing circuitry responsive to the instruction to perform, when the instruction comprises a request specifying a target memory address and the request specifying the target memory address is permitted, an operation dependent on the target memory address. For example, a load or store instruction specifying the target memory request may comprise a request to read or write to a target memory location associated with the target memory address, while a branch instruction (which could, in some examples, be a function call or function return instruction) specifying the target memory address may comprise a request for execution to branch to an instruction stored at the target memory location. However, it should be appreciated that other types instruction (other than load, store and branch instructions) could also include such requests.

It can be useful to provide mechanisms to protect data and instructions stored in memory from read and write accesses issued by code regions within a process which are not permitted to access those data/instructions, and to prevent execution from branching to certain regions of code. One way to do this could be to define permissions which are dependent on the target memory address—such permissions could be defined in a table such as a page table. However, such permissions do not consider the source of the request—the permissions do not define which processes or parts of processes are permitted to access/branch to which locations in memory. Hence, unless the permissions in the page tables are updated, all instructions have the same access rights to a given memory page. Updating these permissions can incur significant latency, since it requires accesses to be made to memory, and hence such updates may only be performed between processes, in which case within any one process (or application) all of the code in that application typically has equal privileges to read/write/execute data/instructions from any given memory location.

Another approach could be to additionally include a “permission overlays” or “permission keys” mechanism that can dynamically revoke certain permissions, according to the programming of a CPU register that revokes or modifies certain permissions. For example, if permissions are defined in page tables (for example), there may be a number of bits of “overlay index” in page table entries. Each page of memory is thus annotated with a “key”, and there is a programmable “overlay interpretation” register that can subtract permissions. For example, the overlay interpretation register could indicate changes such as “remove write access from pages with index 2” or “toggle index 3 from writeable to executable”.

However, even this approach provides only a temporal view of the permissions: neither of the approaches defined above consider the source of an access request (e.g. the instruction comprising the request), since the permissions are determined solely from “what was last written to the configuration register?” not “what code is executing right now?”. As a result, since the permissions are derived from a current value of a register and what is currently stored in the page table entries, a loss of control flow integrity (for example) can lead to a loss of integrity of other portions of memory (e.g. due to execution branching to an unexpected location, without the overlay interpretation register or the page table entries being updated, when the expected path of program flow reaching that location should have involved an update to the to the overlay interpretation register or page table entries).

To address this issue, the present technique provides a mechanism in which permissions are defined which are code-spatial (e.g. which depend on the source of the memory access request), rather than being only code-temporal (e.g. depending on when the request was issued).

In particular, the apparatus of the present technique comprises memory security circuitry to, when the instruction comprises the request specifying the target memory address, determine a current region identifier (also referred to as a “RegionID”) based on a predetermined slice of the instruction fetch address. The RegionID thus depends on the source of the request (e.g. the instruction), rather than being dependent on only the target of the request (e.g. the target memory address—although it will be appreciated that the permissions for a particular RegionID could also depend on the target of the memory access). The memory security circuitry is configured to identify, based on the current region identifier, permissions information for requests issued in response to instructions associated with the current region identifier, and determine, based on the permissions information, whether the request is prohibited. The memory security circuitry is also configured to issue, in response to determining that the request is prohibited, a response to the processing circuitry indicating that the request is prohibited.

The RegionID is determined based on the instruction fetch address for the instruction which requested to access/branch to a memory location identified by the target memory address (and may optionally also depend on other factors). Therefore, since the permissions information is looked up based on the RegionID, the memory security circuitry determines whether a request is prohibited based on the source of the request. This allows the memory security circuitry to enforce fine-grained permissions which are dependent on the specific location within the process/application on behalf of which requests are issued, and to maintain the integrity of regions of code even if there is a loss of control flow integrity. Moreover, determining the RegionID based on a slice of the instruction fetch address provides a simple, low cost mechanism for determining a RegionID, which can avoid the need to, for example, implement expensive/high-latency table lookups based on the instruction fetch address. Note that, if the permissions information indicates that request is permitted, the access request may still ultimately be rejected if, for example, it fails to pass any other checks performed by the apparatus.

The present technique also provides a mechanism for defining different permissions for different instructions, which could—for example—be different parts of a single process or application (e.g. since the permissions are dependent on the source of the requests, rather than based only on the target of the request, or on a value in a configuration register which needs to be updated to update the permissions set). Hence, the present technique can, for example, be useful in applications and in operating system (OS) kernels, for hardening the core security components of the software. In an OS kernel, this mechanism can, for example, be used to harden kernel memory management code and structures against accidental or malicious tampering by other kernel components. It can also be used to sandbox kernel drivers, without the performance overhead of delegating such components into discrete processes. The same benefits apply within an application: for example, by protecting memory allocation library code/structures, and/or the dynamic linker code/structures, against tampering by the rest of the application. It can also provide a benefit to applications that include a sandbox environment for handling untrusted input, or a just-in-time (JIT) environment.

In some examples, the memory security circuitry is configured to determine, based on the page table access permissions information derived from a page table entry associated with the target memory address, whether the request is prohibited. In these examples, the memory security circuitry is configured to issue, in response to determining that the request is prohibited based on at least one of the permissions information and the page table permission information, the response indicating that the request is prohibited.

While defining permissions based on the source of a request is advantageous for the reasons set out above, the present technique can be particularly effective if these permissions are provided in addition to page table access permissions defined in page tables, which depend on the target memory address specified by the request. In such examples, if the permissions defined in relation to the RegionID differ from those defined based on the page table entry for the target memory address, the memory security circuitry is configured to treat the more restrictive permissions as correct (e.g. by issuing the response indicating that the request is prohibited if either one or both sets of permissions indicates that the request is prohibited).

In some examples, the memory security circuitry is configured to determine, based on the predetermined slice of the instruction fetch address, a source region identifier corresponding to a region of memory storing the instruction, and to determine the current region identifier in dependence on the source region identifier.

As explained above, the current region identifier is dependent on the instruction fetch address. In this example, this dependence is expressed by a source region identifier (also referred to as a spatial region identifier (SRegionID)), which corresponds to a region of memory storing the instruction (and hence to a region of address space comprising the instruction fetch address).

In some examples, the processing circuitry is responsive to a return-spatial-identifier instruction identifying a destination register to determine a current source region identifier and store the current source region identifier in the destination register.

This provides a mechanism by which, for example, a shared library can identify which region of code called (branched into) it. Note that the return-spatial-identifier instruction could be a dedicated instruction, or it could be a modification to an existing instruction—for example, the current source region identifier could be stored in a system register field, and the return-spatial-identifier instruction could be an instruction to read that field of the system register.

In some examples, the apparatus comprises a register to store a current temporal identifier, wherein the memory security circuitry is configured to determine the current region identifier dependent on the source region identifier and the current temporal identifier, the current temporal identifier being looked up independent of the instruction fetch address. In these examples, the processing circuitry is responsive to detection of an instruction having a given source region identifier which is different to a source region identifier associated with a previous instruction, to set the current temporal identifier to a predetermined value.

In addition to the spatial component (e.g. the source region identifier), the current region identifier in this example also has a temporal component (e.g. based on the current temporal region identifier, TRegionID), and this identifier is forced to a predetermined value (e.g. this could be zero) in response to a change in the source region identifier. This approach provides additional security against a loss of control flow integrity, since a branch to a different region of code forces the temporal region identifier to a predetermined value, which can (for example) be associated with a predetermined set of permissions.

In some examples, the apparatus comprises a configuration register to store slice identification information indicative of the predetermined slice of the instruction fetch address.

The bits of the instruction fetch address that are used as the predetermined slice could, in some examples, be hardwired (e.g. not configurable by software). However, in this example, the predetermined slice is identified by slice identification information stored in a configuration register. This configuration register can be made accessible to software, allowing the slice identification information to be configured by software.

The way in which the slice identification information is represented is not particularly limited. It could, for example, be represented as an indication of the first and last bit positions (i.e. the most and least significant bit positions) of the instruction fetch address to be used as the predetermined slice (e.g. if bits 44:38 of the instruction fetch address are to be used, the slice identification information may identify bit positions 44 and 38). Alternatively, the configuration register could store an indication of either the first or the last bit position of the slice and a number of bits in the slice (e.g. in the example where bits 44:38 are used, either bit position 44 or bit position 38 could be identified, and the number of bits in the slice could be indicated to be 7).

In some examples, the memory security circuitry is responsive to determining that a further slice of the instruction fetch address has a value other than a predetermined value to determine that the source region identifier is a default source region identifier.

It can be useful to identify a further slice of the instruction fetch address, and use this to provide additional information about the source region identifier. For example, it could be determined that if this further slice holds a particular value (or a value other than some predetermined value), a default source region identifier is to be used. This provides additional flexibility in which regions of memory are associated with which source region identifiers. For example, this approach can be used to require that region identification only occurs for a particular larger region of the address space, so that (for example) an application can operate with an “ambient” address space (for example with a default source region identifier of zero), with a number of regions carved out from it. This permits selection of a set of small regions of address space for sandboxing within the process/application, while the majority of the address space is for any less-trusted components in the application. Using the further slice as a mask to provide this ambient address space has only a small hardware cost, since it is a simple mask that can be applied at the front-end of the microarchitecture, meaning that the rest of the apparatus (e.g. a CPU pipeline) can be informed of the source region identifier up front.

In the above examples, the way in which the predetermined slice of the instruction is used to determine the source region identifier is not particularly limited. However, in particular examples, the predetermined slice may be used directly as the source region identifier. This provides approach requires less complex circuitry than alternative approaches where, for example, the predetermined slice is used to indirectly determine the identifier (e.g. by applying some function to the predetermined slice, or using the predetermined slice to look up a storage structure to determine the source region identifier). However, a downside of using the predetermined slice directly as the source region identifier may be that there is less flexibility in which regions or memory are allocated to which source region identifiers.

In some examples, the instruction fetch address comprises a virtual address, the instruction fetch circuitry is configured to fetch the instruction in dependence on a given portion of the instruction fetch address, the given portion of the instruction fetch address indicating a location in memory at which the instruction is stored, wherein the given portion of the instruction fetch address and the predetermined slice of the instruction fetch address overlap by at least one bit.

In some architectures, processes may reference locations in memory using virtual addresses, which can be translated into physical addresses identifying locations in memory. This can allow, for example, multiple different virtual address spaces to be defined, each with their own mapping to the physical address space. For example, different processes may have different virtual address spaces.

This can lead to situations in which multiple different virtual addresses map onto the same physical address—for example, if multiple different processes with different virtual address spaces wish to access a given instruction in a shared library of code, each may reference that instruction using a different virtual address. This is known as aliasing. However, aliasing can affect the performance of the apparatus—for example, entries in a translation lookaside buffer or an instruction cache could be indexed and/or tagged by virtual address, meaning that each aliasing virtual address would map onto a different entry. This can lead to multiple copies of the same instruction/translation being stored in separate entries of the cache/TLB, taking up space which could otherwise be used to store other instructions.

One could address issues such as these by not permitting aliasing—for example, by requiring the given portion of the instruction fetch address to be the same for each virtual address mapping onto a particular physical address. However, it can be useful to retain, in the given portion, some information indicating which process/section of code a particular instance of the aliasing virtual addresses originates from. To address this, the inventor of the present technique proposes allowing one or more bits of the given portion (used to identify the corresponding physical address) to overlap with one or more bits of the predetermined slice (used to determine the source region identifier). These bits could, for example, be different for aliasing virtual addresses, while the other bits in the given portion are kept the same. This allows structures such as caches to be looked up based on the given portion excluding the overlapping bits, so that only one copy of an instruction from a given physical address is stored in the cache, while still retaining information to distinguish the aliasing addresses.

In some examples, the memory security circuitry is configured to determine whether the request is prohibited based on the permissions information identifying at least one of:
read access permissions;
write access permissions;
permissions for performing branches; and
permissions for performing branches without causing a return address to be stored.

Hence, the access permissions information may indicate any combination of read, write and execute instructions, and may further indicate when branches are required to be performed as function calls (saving a return address).

In some examples, the memory security circuitry is configured to determine, based on the target memory address, a destination region identifier. In these examples, the memory security circuitry comprises table access circuitry to look up, based on the current region identifier and the destination region identifier, a permissions table in memory, the permissions table defining the permissions information. Further, in these examples, the table access circuitry is configured to support at least one encoding of the permissions table in which different permissions information is defined for different combinations of the current region identifier with different destination region identifiers.

In this example, the permissions table can be considered to be a two-dimensional table, in that it is looked up based on both a current region identifier (determined in dependence on the instruction fetch address) and a destination region identifier (determined in dependence on the target memory address). This allows permissions information to be defined for multiple different combinations of current region identifier and target region identifier, so that it can be determined whether the currently executing portion of code is permitted to access/branch to the specific memory location indicated by the target memory address of the request. This allows specific regions of code to be given or refused access to specific regions of memory.

In some examples, the memory security circuitry comprises table access circuitry to access, in memory, a permissions table defining the permissions information, and the apparatus comprises a table identifying register to store address information indicative of a location of the permissions table in memory.

For example, the address information could be a base address of the table in memory. The table access circuitry uses the address information to locate the table in memory.

In some examples, the apparatus is arranged to operate in one of a plurality of privilege levels, and the apparatus comprises a plurality of registers, each being configured to store address information indicative of a location of a corresponding permissions table in memory.

In these examples, the apparatus also comprises register selection circuitry to select, based on a current privilege level, one of the plurality of registers as the permissions table identifying register.

In this example, a separate permissions table can be defined for each privilege level. For example, there could be one register for the kernel and one for userspace. This allows, for example, more restrictive permissions to be defined when the apparatus is operating in a less-privileged level.

In some examples, the memory security circuitry comprises table access circuitry to access, in memory, a permissions table defining the permissions information, the apparatus comprises a register to store a current set of permissions indicative of the permissions information defined in the permissions table for the current region identifier, and the table access circuitry is responsive to determining that the current region identifier has changed to a new region identifier to look up, based on the new region identifier, the permissions table to identifier and an updated set of permissions to be stored in the register.

Thus, the permission information associated with the current region identifier can, in this example, be loaded into a register so that it can be accessed with reduced latency. Then, each time the current region identifier changes, the permissions information in the register can be replaced with an updated set of permissions associated with the new region identifier.

The format of the register is not particularly limited, but the register could, for example, comprise a field for each of a plurality of target region identifiers, each field storing corresponding permissions information (e.g. a bit to indicate each permission-such as a read bit, a write bit and an execute bit).

In some examples, the memory security circuitry comprises table access circuitry to access, in memory, a permissions table defining the permissions information, and the apparatus comprises a cache to store a subset of the permissions defined in the permissions table. In these ecamples, the apparatus is configured to operate in a one of a plurality of contexts, each associated with a context identifier, and the cache comprises a plurality of entries, each associated with a corresponding context identifier.

Hence, in this example, some permissions information can be cached so that future accesses to the permission information can be performed with reduced latency, thus improving performance. Moreover, associating each entry with a context identifier (e.g. this could be a combination of a virtual machine identifier (VMID) and an address space identifier (ASID)), avoids the need to flush the cache on a context switch, hence improving performance since the cached data can still be available for access in future.

In some examples, the apparatus comprises a plurality of registers comprising, for each of a plurality of current region identifiers, a register to store a set of permissions indicative of permissions information for that current region identifier.

These registers could be provided instead of or in addition to a permissions table in memory. While adding additional registers can increase the circuit area taken up by the apparatus, such registers can be advantageous as they may be accessible with reduced latency (hence allowing the performance of the apparatus to be improved).

As with the example above, the format of the registers is not particularly limited, but each of the registers could, for example, comprise a field for each of a plurality of target region identifiers, each field storing corresponding access permissions information.

The techniques discussed above can be implemented in a hardware apparatus which has circuit hardware implementing the instruction fetch circuitry, processing circuitry and memory security circuitry described above. However, in another example the same techniques may be implemented in a computer program (e.g. an architecture simulator or model) which may be provided for controlling a host data processing apparatus to provide an instruction execution environment for execution of instructions from target code. These instructions could, in some particular examples, include any of the return-spatial-identifier instruction, the temporal identifier update instruction, the branch-and-change-temporal-identifier instruction and the branch-and-keep-temporal-identifier instruction.

The computer program may include instruction fetch program logic to fetch instructions of the target code, and processing program logic to control a host data processing apparatus to perform data processing in response to the instructions. Hence, the instruction fetch program logic emulates the functionality of the instruction fetch circuitry of a hardware apparatus as discussed above, and the processing program logic emulates the processing circuitry.

Also, in some examples, some or all of the registers described above could be emulated—in particular, the program may include register maintenance program logic which maintains a data structure (within the memory or architectural registers of the host apparatus) which represents (emulates) the architectural registers of the instruction set architecture being simulated by the program. The emulated registers may include any of the plurality of registers described in some examples above.

Hence, such a simulator computer program may present, to target code executing on the simulator computer program, a similar instruction execution environment to that which would be provided by an actual hardware apparatus capable of directly executing the target instruction set, even though there may not be any actual hardware providing these features in the host computer which is executing the simulator program. This can be useful for executing code written for one instruction set architecture on a host platform which does not actually support that architecture. Also, the simulator can be useful during development of software for a new version of an instruction set architecture while software development is being performed in parallel with development of hardware devices supporting the new architecture. This can allow software to be developed and tested on the simulator so that software development can start before the hardware devices supporting the new architecture are available.

Particular embodiments will now be described with reference to the figures.

FIG. 1 schematically illustrates a data processing apparatus 100 within which examples of the present technique may be implemented. As shown in the figure, the data processing apparatus 100 comprises instruction fetch circuitry 105 to fetch instructions from memory (optionally via one or more caches). The fetch circuitry 105 fetches instructions from memory locations identified by instruction fetch addresses (e.g. these could be memory addresses defining locations in the memory at which the instructions are stored), or from one or more intervening caches (not shown). In the example of FIG. 1, the instruction fetch address of the next instruction to be fetched by the instruction fetch circuitry 105 is held in a program counter (PC) register 110, which is one of a set of registers 115 provided in this example. The PC register 110 identifies the next instruction to be fetched, and hence is incremented each time an instruction is fetched (so that it points to the next instruction in the program order). The register file 115 also comprises other registers including, in this example, a temporal region identifier register 130 storing a temporal region identifier (TRegionID). This will be disclosed in more detail below.

The instruction fetch circuitry 105 provides instructions to instruction decode circuitry 120, which decodes the instructions and issues, to processing circuitry 125, control signals to control the processing circuitry 125 to execute the decoded instructions. The processing circuitry 125 executes the decoded instructions with reference to data stored in the registers 115 (for example, the processing circuitry may read operands for data processing operations from the registers and store the results of the data processing operations to the registers).

The processing circuitry 125 also, in response to some instructions, issues memory access requests to access data or instructions stored memory. For example, the processing circuitry 125 may issue memory access requests to a memory controller (not shown) to load data from memory into the registers, or to store data from the registers into memory. The processing circuitry 125 may also, in response to control flow instructions such as branch instructions, update the value stored in the PC register 110 in order to change the flow of instructions to be fetched by the instruction fetch circuitry 105.

The data processing apparatus in this example also comprises memory security circuitry 135, which will be described in more detail below.

In many contemporary hardware and software architectures, read and write permissions to load or store data to/from particular regions of memory and execute permissions to fetch instructions from particular regions of memory are controlled by permissions described in page tables (e.g. multi-level page tables) programmed by the operating system and stored in memory. For example, a memory controller or a memory management unit (which controls access to memory in response to memory access requests, including requests to load/store data and requests to fetch instructions) may comprise page table walk circuitry to access the page tables and identify the permissions for a particular access request. In particular, the page table is looked up based on the target memory address of an access request (e.g. the address of the data or instruction to be accessed) to identify the relevant permissions. Thus, such access permissions are defined on the basis of the target of the access request, and not based on the instruction on behalf of which the access request was issued.

Within any one process (or application) all of the code in that application has, in a typical data processing apparatus, equal privileges to read/write/execute any memory in its address space—for example, different instructions within a given process typically have the same permissions. As explained above, some architectures additionally include a “permission overlays” or “permission keys” mechanism that can dynamically revoke certain permissions, according to the programming of a CPU register that allows certain permissions to be revoked or modified—for example, page table entries may be annotated with these overlay bits/keys, and the programming of the CPU register may indicate (for example) that a given permission should be revoked for any pages which are associated with a certain key value (e.g. “revoke read access for permission key 2”). This allows the access permissions defined in the page tables to be modified, but only provides a temporal view of the permissions. The inventor of the present technique realised that this could lead to potential issues, for example if there is a loss of control flow integrity (e.g. if control flow is allowed to branch to an unexpected region of code).

FIGS. 2 to 3 help to illustrate how this issue could arise. In particular, FIGS. 2A and 2B illustrate examples of permissions which one might wish to define for a particular address space 200. As shown in the figures, different portions of code (“Code 1”, “Code 2” and “Code 3”) and different data (“Data A” and “Data B”) may be stored in different regions of the address space. Each of these different regions may have different read/write access permissions, which might additionally be dependent on what code is executing at any particular point in time. For example, as shown in FIG. 2A, instructions fetched from code region 1 (Code 1) may have read (R) and write (W) access to (e.g. permission to load data from and store data to) data region A (Data A), but no access to the data stored in data region B (Data B). Meanwhile, code region 3 (Code 3) may have read-only (RO) access to data region A, and read and write access to data region B.

Similarly, as shown in FIG. 2B, each code region may have different execute access permissions (e.g. defining whether instructions from a given code portion are permitted to branch to instructions in a different code portion). For example, instructions from code region 1 are, in this example, permitted to branch to instructions in code region 2 and code region 4 (Code 4), while instructions from code region 3 are permitted to branch to instructions in code region 2 but not to instructions in code region 4.

One might expect that the permission overlays mechanism defined above could be used in enforcing these permissions, for example by changing the contents of the overlay interpretation register when switching from one code region. However, this mechanism is less effective in cases where there is a loss of control flow integrity, as will be explained below with reference to FIGS. 3A and 3B.

FIGS. 3A and 3B show examples of how instructions from different code regions may be executed. FIG. 3A shows an example of an expected flow of instructions. As shown, before switching from code region 3 to code region 1, an instruction is executed to update a configuration register, so that the access permissions defined by the page tables in combination with the overlay bits are updated. Following this update, an instruction from code region 1 (Instruction C) is executed, causing the processing circuitry to issue an access request to read data in region B. However, the configuration register in combination with the overlay bits and the permissions in the page tables indicate that the read accesses to data region B are prohibited, and hence the access request is rejected.

However, FIG. 3B illustrates how a loss of control flow integrity can lead to a loss of data integrity. For example, FIG. 3B shows what might happen if an instruction from code region 3 unexpectedly branches to an instruction to code region 1. In this case, Instruction A branches to Instruction C, without the configuration register being updated. This means that when Instruction C is executed, the permissions defined by the configuration register in combination with the page tables are still as they were for code region 3. Instructions from code region 3 are permitted to both read and write access to data region A, and hence the read access to data region B is permitted. Hence, due to a loss of control flow integrity, the integrity or confidentiality of the data stored in data region B may be lost. In other words, the integrity/confidentiality of the data stored in data region B depends on control flow integrity being maintained.

The present technique provides a mechanism to address this issue. In particular, the present technique defines a source region identifier (also referred to as a spatial region identifier, SRegionID) which is dependent on the instruction fetch address of the instruction requesting access to a particular memory location (whether that is read, write or execute access). This allows access permissions information to be defined in dependence on the source of an access request, rather than just being dependent on the destination of the access request and/or the timing of the access request.

For example, FIG. 4 illustrates how a spatial region identifier (SRegionID) could be determined based on the instruction fetch address (which could be obtained from the PC register). The spatial region identifier may be determined by the memory security circuitry 135 in response to a memory access request issued by the processing circuitry.

In FIG. 4, a 64-bit instruction fetch address is shown, although it will be appreciated that this is just an example-the instruction fetch address may have a size that is implementation-dependent, although the examples illustrated in FIG. 4 may be more suitable for architectures which employ larger address widths, such as 64-bit address widths and greater. The spatial region identifier is determined based on a selected portion of the instruction fetch address, with some state (e.g. a register) 400 in the memory security circuitry 135 indicting which bits of the instruction fetch address are to be used—for example, the state 400 in the memory security circuitry could indicate the first and last bit positions of the portion to be used, or the first/last bit position and a size of the portion. In alternative examples, the portion of the instruction fetch address to be used may be hardwired, rather than being programmable in a configuration register.

FIG. 4 shows, in “A”, an example of a typical format of a 64-bit PC. The figure also shows three examples (B, C, D) of portions of the instruction fetch address to be used as or to derive the spatial region identifier. In all four examples, the instruction fetch address includes a number of canonical/tag bits, and useful VA (virtual address) bits which define the location in memory at which the instruction is stored. Examples B, C and D each include the portion (SRegionID) to be used to derive the spatial region identifier. It should be noted that, while the example shows a virtual instruction fetch address being used to determine the spatial region identifier, it could instead be a physical address which is used.

The first example (A) shows an example of a typical instruction fetch address. The canonical/tag bits occupy bit positions 63:49 of the instruction fetch address, and the remaining bits 48:0 are all useful VA bits.

In the second example (B), the same bits 63:49 are used as canonical/tag bits, but bits 44:38 are used to derive the spatial region identifier. In this example, an additional constant is defined in bit positions 48:45 which can provide additional information—for example, the memory security circuitry could be arranged to determine, when the constant has certain values, that a default spatial region identifier should be used. This leaves bits 37:0 to define the useful VA bits.

In the third example (C), the same bits 63:49 are again used as canonical/tag bits, but bits 48:45 are used to derive the spatial region identifier. This leaves bits 44:0 to define the useful VA bits.

In the fourth example (D), bit positions 63:55 are used to derive the spatial region identifier, with the number of canonical/tag bits being reduced to occupy bit positions 54:49. This leaves bits 48:0 to define the useful VA bits.

In all of the examples B to D, a selection of bits of the instruction fetch address are used to determine the spatial region identifier, so that the spatial region identifier is dependent on the source of a memory access request (e.g. dependent on the instruction fetch address of the instruction that caused the memory access request to be issued), rather than on the destination of the memory access request (e.g. the target address of the data or instruction to be accessed). The way in which the selected bits are used to determine the spatial region identifier is not particularly limited. In some examples, the selected bits could be used directly as the spatial region identifier, while in other examples the selected bits may be mapped to a spatial region identifier by the memory security circuitry in some other manner.

In some examples, the SRegionID portion and the useful VA bits might overlap by a number of bits (e.g. a number of bits are used both to determine the SRegionID and to determine the location in memory at which the instruction is stored). As explained above, this can provide a mechanism to distinguish between aliasing virtual addresses, in situations where the software is forced to keep all of the other VA bits constant between aliasing virtual addresses. Moreover, the useful VA bits can, in some examples, include all of the SRegionID bits

In some examples, the architecture may support multiple techniques for determining the SRegionID based on the instruction fetch address. For example, two or more of the approaches shown in FIG. 4 could be supported-for example, the PC bits register 400 could be configurable, so that the bits to be treated as the SRegionID slice are programmable.

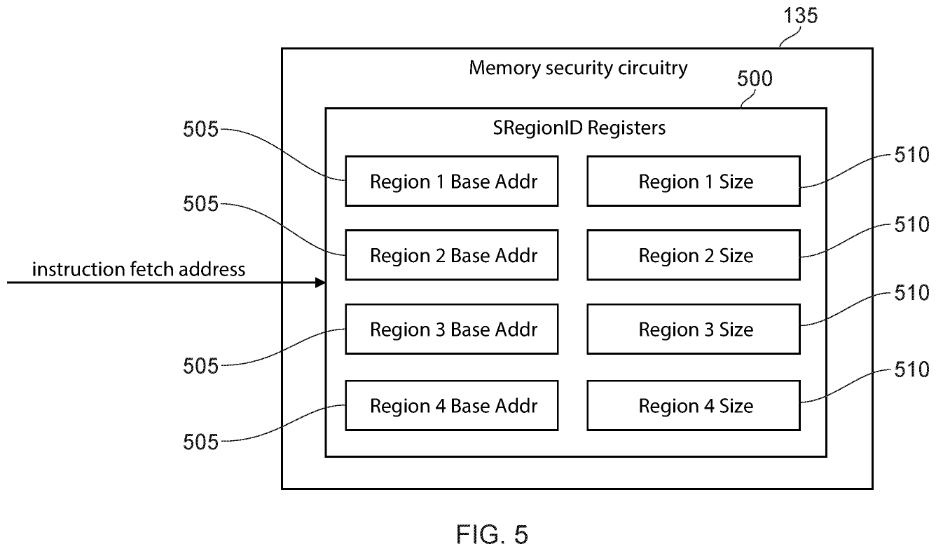

Moreover, additional mechanisms could be supported by the architecture, in addition to supporting the use of a slice of the instruction fetch address to determine the SRegionID. This can provide additional flexibility to chip designers using the architecture. For example, FIG. 5 shows another approach to determining the spatial region identifier. In particular, the memory security circuitry 135 as shown in FIG. 5 comprises a set 500 of registers which map different regions of address space (e.g. virtual or physical) to region identifiers. In the particular example shown in FIG. 5, a pair of registers are provided for each of a plurality of spatial region identifiers, the pair including a base address register 505 identifying a base address of a corresponding region in memory and a size register 510 identifying a size of the corresponding region in memory. The memory security circuitry is, in this example, arranged to compare all or part of the instruction fetch address with the base addresses and sizes indicated by the registers, to determine which of the regions the instruction fetch address falls within. The spatial region identifier is then the identify corresponding to that region.

Note that, the size of each region can be indicated as, for example, a number of bytes of memory in the corresponding region, a number of pages in the memory region, a number of bits of the base address to mask out as part of the region identification, or as an end address of the region in memory.

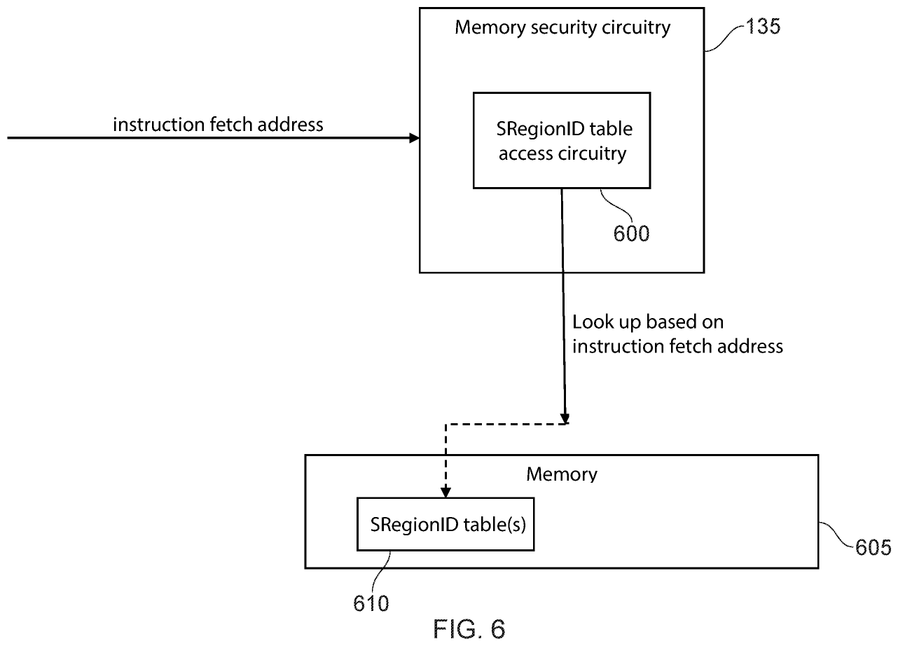

FIG. 6 shows another additional mechanism which could be supported in the architecture In this example, the memory security circuitry 135 comprises table access circuitry (also referred to as SRegionID table access circuitry, spatial region identifier table access circuitry, or source region identifier table access circuitry) 600. The SRegionID table access circuitry is responsive to a memory access request to look up, based on the instruction fetch address of the instruction which caused the memory access request to be issued, a table in memory 605. The table 610 defines a mapping of spatial region identifiers to instruction fetch addresses.

When a table in memory is used to define the mapping of instruction fetch addresses to spatial region identifiers, as in the examples shown in FIG. 6, the memory security circuitry may also comprise one or more caches to cache data from the table in memory.

Accordingly, the spatial region identifier is dependent on the source of the memory access, and therefore may also be referred to as the source region identifier. A set of memory access permissions (e.g. read/write permissions) can then be defined which are dependent on the spatial region identifier (and optionally may also be dependent on the target address of the memory access). Such permissions may be defined in addition to those defined in the page tables.

Moreover, while much of the discussion above focusses on permissions defined for memory accesses (e.g. loads and stores of data or instructions from/to memory), it should be appreciated that execute permissions may also be defined in dependence on the spatial region identifier—for example, the spatial region identifier of a branch instruction may be used to determine whether or not the branch is permitted.

Access permissions may further be dependent on a temporal region identifier (TRegionID), which may be stored in the temporal identifier register 130 shown in FIG. 1. This register may be software-accessible, in which case the temporal region identifier can be updated by instructions executed by the processing circuitry. In particular examples, a region identifier (RegionID) is defined which is a concatenation of the spatial region identifier (SRegionID) and the temporal region identifier (TRegionID).

FIG. 7 shows an example of how read, write and execute permissions may be defined based on region identifiers. In this particular example, access permissions for a given memory access request or branch request are defined for each of a number of combinations of a current region identifier (e.g. the concatenation of the spatial region identifier of the requesting instruction and the current temporal region identifier) and a target region identifier (e.g. the concatenation of the spatial region identifier of the target address and the current temporal identifier). Hence, the table shown in FIG. 7 can be considered to be a two-dimensional (2D) table, since it is looked up by both the current region identifier and the target region identifier.

In the table, “RW” indicates that read and write accesses are permitted, “RO” indicates that read accesses are permitted but write accesses are not permitted, “X” indicates that branches are permitted and “XL” indicates that function calls (branches where a return address is saved, e.g. to a link register) but other kinds of branch are not. A dash “-” indicates that no access is permitted.

The table (which may be referred to as a permissions table, for example) may be stored in memory. The table may be a single table, or it may be a multi-level table, for example. In some example, the branch and function call permissions (“X” and “XL”) may be defined in a separate table or bitmap, with the permissions table defining only the read and write permissions.

FIG. 8 shows an example of the circuitry which may be used to identify and access one or more permissions tables such as the one shown in FIG. 7. In this example, the memory security circuitry 135 comprises permissions table access circuitry 800 to access the permissions tables 805 in memory 605. The base addresses of the permissions tables are defined in a set of registers 810. In this particular example, it is assumed that the data processing apparatus is capable of operating in any of three privilege levels, and that a table is defined for each privilege level. Accordingly, a register 815 is provided to store the base address of each table in memory, and the permissions table access circuitry accesses the permissions table based on the base address stored in the corresponding register. The memory security circuitry in this example also comprises one or more permissions table caches 820, arranged to cache a subset of the contents of the permissions tables. The entries in the permissions table caches may be tagged by a virtual machine identifier (VMID) and an address space identifier (ASID) so that the cache does not need to be flushed each time there is a context switch. Alternatively, the caches may be tagged by some alternative context identifier.

In the example shown in FIG. 8, only some of the circuitry which might be present in the memory security circuitry 135 is shown. It should be appreciated that the memory security circuitry in this example may also include circuitry such as the SRegionID table access circuitry 600, the SRegionID registers 500 or the PC bits register shown in the other figures. Further, while this example assumes that the data processing apparatus is capable of operating in multiple different privilege levels, this is not essential.

FIG. 9 is a flow diagram illustrating an example of a method which may be performed by a data processing apparatus in response to a memory access request being issued. Note that a similar method could also be performed in response to execution of a branch instruction.

As shown in the figure, the method includes a step 900 of reading the current temporal region identifier from the TRegionID register, and a step 905 of determining the current spatial region identifier (SRegionID) based on the instruction fetch address of the instruction whose execution lead to the memory access request being issued. The method also includes a step 910 of determining the target spatial region identifier (i.e. the spatial region identifier corresponding to the target of the access request) based on the target address of the memory access request. Having determined the current temporal region identifier and the current spatial identifier, the method includes a step 915 of determining the current region identifier (RegionID) based on the current spatial and temporal region identifiers (e.g. the RegionID could be a concatenation of the SRegionID and the TRegionID, as explained above). Also, the method includes a step 920 of determining the target region identifier (RegionID) based on the target spatial region identifier and the current temporal region identifier. Having determined the current and target region identifiers, the method includes a step 925 of looking up a permissions table based on these two identifiers-for example, this could be a lookup in a table such as that shown in FIG. 7.

FIG. 10 is another flow diagram, in this case illustrating an example of how the data processing apparatus may react to the execution of branch instructions. In particular, in some examples the data processing apparatus may be arranged to set, when execution of a branch instruction causes the spatial region identifier (SRegionID) to change (e.g. when the branch instruction is associated with one spatial region identifier and the target of the branch instruction is associated with a different spatial region identifier), the temporal region identifier to zero (or some other default value). This helps to maintain control flow integrity.

In particular, the method shown in FIG. 10 comprises a step 1000 of determining whether a branch instruction is executed. When it is determined that a branch instruction has been executed, the method comprises a step 1005 of determining whether execution of the branch instruction has caused the spatial region identifier to change. When it is determined that this is the case, the temporal region identifier is set 1010 to zero.

FIG. 11 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 1330, optionally running a host operating system 1320, supporting the simulator program 1310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. In the example shown in FIG. 11, instruction fetch program logic 1340 is provided, which provides the same functionality as the instruction fetch circuitry of previous examples. In addition, processing program logic 1350 is provided which provides the same functionality as the processing circuitry described above, and memory security program logic 1360 is provided, which provides the functionality of the memory security circuitry in the above examples. Similarly, memory hardware, such as a register or cache, may be implemented in a simulated embodiment as a software data structure. In arrangements where one or more of the hardware elements referenced in the previously described embodiments are present on the host hardware (for example, host processor 1330), some simulated embodiments may make use of the host hardware, where suitable.

The simulator program 1310 may be stored on a computer-readable storage medium (which may be a non-transitory medium), and provides a program interface (instruction execution environment) to the target code 1300 (which may include applications, operating systems and a hypervisor) which is the same as the interface of the hardware architecture being modelled by the simulator program 1310. Thus, the program instructions of the target code 1300, including instructions which require memory access requests to be issued, branch instructions, function call instructions and function return instructions as described above, may be executed from within the instruction execution environment using the simulator program 1310, so that a host computer 1330 which does not actually have the hardware features of the apparatus 100 discussed above can emulate these features.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Further, the words “comprising at least one of . . . ” in the present application are used to mean that any one of the following options or any combination of the following options is included. For example, “at least one of: A; B and C” is intended to mean A or B or C or any combination of A, B and C (e.g. A and B or A and C or B and C).

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
instruction fetch circuitry responsive to an instruction fetch address to fetch an instruction associated with the instruction fetch address;
processing circuitry responsive to the instruction to perform, when the instruction comprises a request specifying a target memory address and the request specifying the target memory address is permitted, an operation dependent on the target memory address; and
memory security circuitry to, when the instruction comprises the request specifying the target memory address:
determine, based on a predetermined slice of the instruction fetch address, a current region identifier;
identify, based on the current region identifier, permissions information for requests issued in response to instructions associated with the current region identifier;
determine, based on the permissions information, whether the request is prohibited; and
issue, in response to determining that the request is prohibited, a response to the processing circuitry indicating that the request is prohibited.

2. The apparatus of claim 1, wherein
the memory security circuitry is configured to:
determine, based on page table access permissions information derived from a page table entry associated with the target memory address, whether the request is prohibited; and
issue, in response to determining that request is prohibited based on at least one of the permissions information and the page table permission information, the response indicating that the request is prohibited.

3. The apparatus of claim 1, wherein
the memory security circuitry is configured to determine, based on the predetermined slice of the instruction fetch address, a source region identifier corresponding to a region of memory storing the instruction, and to determine the current region identifier in dependence on the source region identifier.

4. The apparatus of claim 3, wherein
the processing circuitry is responsive to a return-spatial-identifier instruction identifying a destination register to determine a current source region identifier and store the current source region identifier in the destination register.

5. The apparatus of claim 3, comprising
a register to store a current temporal identifier,
wherein the memory security circuitry is configured to determine the current region identifier dependent on the source region identifier and the current temporal identifier, the current temporal identifier being looked up independent of the instruction fetch address; and
the processing circuitry is responsive to detection of an instruction having a given source region identifier which is different to a source region identifier associated with a previous instruction, to set the current temporal identifier to a predetermined value.

6. The apparatus of claim 1, comprising
a configuration register to store slice identification information indicative of the predetermined slice of the instruction fetch address.

7. The apparatus of claim 1, wherein
the memory security circuitry is responsive to determining that a further slice of the instruction fetch address has a value other than a predetermined value to determine that the source region identifier is a default source region identifier.

8. The apparatus of claim 1, wherein:
the instruction fetch address comprises a virtual address;
the instruction fetch circuitry is configured to fetch the instruction in dependence on a given portion of the instruction fetch address, the given portion of the instruction fetch address indicating a location in memory at which the instruction is stored; and
the given portion of the instruction fetch address and the predetermined slice of the instruction fetch address overlap by at least one bit.

9. The apparatus of claim 1, wherein
the memory security circuitry is configured to determine whether the request is prohibited based on the permissions information identifying at least one of:
read access permissions;
write access permissions;
permissions for performing branches; and
permissions for performing branches without causing a return address to be stored.

10. The apparatus of claim 1, wherein:
the memory security circuitry is configured to determine, based on the target memory address, a destination region identifier;
the memory security circuitry comprises table access circuitry to look up, based on the current region identifier and the destination region identifier, a permissions table in memory, the permissions table defining the permissions information; and
the table access circuitry is configured to support at least one encoding of the permissions table in which different permissions information is defined for different combinations of the current region identifier with different destination region identifiers.

11. The apparatus of claim 1, wherein:
the memory security circuitry comprises table access circuitry to access, in memory, a permissions table defining the permissions information; and
the apparatus comprises a table identifying register to store address information indicative of a location of the permissions table in memory.

12. The apparatus of claim 11, wherein:
the apparatus is arranged to operate in one of a plurality of privilege levels; and
the apparatus comprises:
a plurality of registers, each being configured to store address information indicative of a location of a corresponding permissions table in memory; and
register selection circuitry to select, based on a current privilege level, one of the plurality of registers as the permissions table identifying register.

13. The apparatus of claim 1, wherein:
the memory security circuitry comprises table access circuitry to access, in memory, a permissions table defining the permissions information; and
the apparatus comprises a register to store a current set of permissions indicative of the permissions information defined in the permissions table for the current region identifier; and
the table access circuitry is responsive to determining that the current region identifier has changed to a new region identifier to look up, based on the new region identifier, the permissions table to identify an updated set of permissions to be stored in the register.

14. The apparatus of claim 1, wherein:
the memory security circuitry comprises table access circuitry to access, in memory, a permissions table defining the permissions information;
the apparatus comprises a cache to store a subset of the permissions defined in the permissions table;
the apparatus is configured to operate in a one of a plurality of contexts, each associated with a context identifier; and
the cache comprises a plurality of entries, each associated with a corresponding context identifier.

15. The apparatus of claim 1, comprising
a plurality of registers comprising, for each of a plurality of current region identifiers, a register to store a set of permissions indicative of permissions information for that current region identifier.

16. A method comprising
fetching, in response to an instruction fetch address, an instruction associated with the instruction fetch address; and
when the instruction comprises a request specifying a target memory address:
performing, in response to the instruction, when the request specifying the target memory address is permitted, an operation dependent on the target memory address;
determining, based on a predetermined slice of the instruction fetch address, a current region identifier;
identifying, based on the current region identifier, permissions information for requests issued in response to instructions associated with the current region identifier;
determining, based on the permissions information, whether the request is prohibited; and
issuing, in response to determining that the request is prohibited, a response indicating that the request is prohibited.

17. A computer program which, when executed on a computer, causes the computer to provide:
instruction fetch program logic responsive to an instruction fetch address to fetch an instruction associated with the instruction fetch address;
processing program logic responsive to the instruction to perform, when the instruction comprises a request specifying a target memory address and the request specifying the target memory address is permitted, an operation dependent on the target memory address; and
memory security program logic to, when the instruction comprises the request specifying the target memory address:
determine, based on a predetermined slice of the instruction fetch address, a current region identifier;
Identify, based on the current region identifier, permissions information for requests issued in response to instructions associated with the current region identifier;
determine, based on the permissions information, whether the request is prohibited; and
issue, in response to determining that the request is prohibited, a response to the processing program logic indicating that the request is prohibited.

18. A computer-readable storage medium to store the computer program of claim 17.
